(19) United States
(12) Patent Application Publication
(10) Pub. No.: US 2007/0252799 A1
(43) Pub. Date: Nov. 1, 2007

(54) Liquid crystal display panel having photoelectric cell unit and mobile phone using same

(75) Inventor: Shuo-Ting Yan, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/796,777

(22) Filed: Apr. 30, 2007

(30) Foreign Application Priority Data
Apr. 28, 2006 (TW) 95115281

(51) Int. Cl. G09G 3/36

(52) U.S. Cl. 345/87

(57) ABSTRACT

An exemplary liquid crystal display (LCD) panel (22) includes a display area (251) and a non-display area (252). The non-display area has a photoelectric cell unit (254) provided thereat. The photoelectric cell unit is configured to generate electrical power when irradiated by light. An LCD device using the LCD panel, and a mobile phone using the LCD device, are also provided.

### FIELD OF THE INVENTION

The present invention relates to liquid crystal display (LCD) panels, and particularly relates to an LCD panel having a photoelectric cell unit and a mobile phone using the LCD panel.

### GENERAL BACKGROUND

Because LCD devices have the advantages of portability, low power consumption, and low radiation, they have been widely used in various portable information products such as mobile phones, notebooks, personal digital assistants (PDAs), video cameras, and the like. Furthermore, LCD devices are considered by many to have the potential to completely replace CRT (cathode ray tube) monitors and televisions.

FIG. 4 is a block diagram of certain components of a typical mobile phone. The mobile phone 1 includes an LCD device 12, a wireless communication system 13, and a battery 14. The battery 14 is configured to respectively provide operation voltages to the wireless communication system 13 and the LCD device 12. The wireless communication system 13 is configured to receive and send radio waves from and to other remote mobile phones (not shown). Typically, the radio waves include voice information signals. The LCD device 12 is configured to display information such as the time, phone numbers needed by a user, and an operating state of the mobile phone 1.

FIG. 5 is an exploded, isometric view of the LCD device 12. The LCD device 12 includes an LCD panel 15 configured to display images, and a backlight module 16 configured to illuminate the LCD panel 15.

The electric power stored in the battery 14 is normally limited by a cell capacitor of the battery 14. Normally, the power consumption of the LCD panel 15 is high, and thus the stand-by time of the mobile phone 1 is correspondingly short.

It is desired to provide an LCD panel which can overcome the above-described deficiencies.

### SUMMARY

In one preferred embodiment, an LCD panel is provided. The LCD panel includes a display area and a non-display area. The non-display area has a photoelectric cell unit provided thereat, the photoelectric cell unit is configured to generate electrical power when irradiated by light. In another preferred embodiment, an associated LCD device is provided. In a further preferred embodiment, an associated mobile phone is provided.

Other novel features and advantages will become more apparent from the following detailed description when taken in conjunction with the accompanying drawings, in which:

### BRIEF DESCRIPTION OF THE DRAWINGS

FIG. 1 is a block diagram of certain components of a mobile phone according to an exemplary embodiment of the present invention, the mobile phone including an LCD device.

FIG. 2 is an exploded, isometric view of the LCD device of the mobile phone of FIG. 1.

FIG. 3 an exploded, isometric view of an LCD device of an alternative exemplary embodiment of the present invention.

FIG. 4 is a block diagram of certain components of a conventional mobile phone, the mobile phone including an LCD device.

FIG. 5 is an exploded, isometric view of the LCD device of the mobile phone of FIG. 4.

### DETAILED DESCRIPTION OF PREFERRED EMBODIMENTS

Reference will now be made to the drawings to describe various embodiments of the present invention in detail.

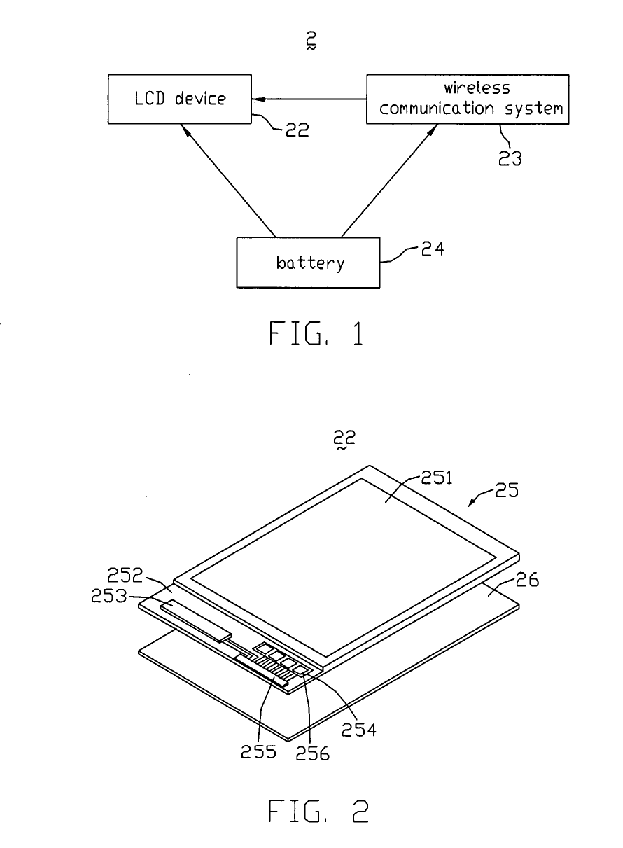

FIG. 1 is a block diagram of certain components of a mobile phone according to an exemplary embodiment of the present invention. The mobile phone 2 includes an LCD device 22, a wireless communication system 23, and a battery 24. The battery 24 is configured to respectively provide operation voltages to the wireless communication system 23 and the LCD device 22. The wireless communication system 23 is configured to receive and send radio waves from and to other remote mobile phones (not shown). Typically, the radio waves include voice information signals. The LCD device 22 is configured to display information such as the time, phone numbers needed by a user, and operating states of the battery 24 and the mobile phone 2.

FIG. 2 is an exploded, isometric view of the LCD device 22. The LCD device 22 includes an LCD panel 25 configured to display images, and a backlight module 26 configured to illuminate the LCD panel 25. The LCD panel 25 includes a main display area 251, and a non-display area 252 at one side of the display area 251. The non-display area 252 has a driver integrated circuit (IC) 253 for driving the display area 251, a photoelectric cell unit 254, and an input/output interface circuit 255. The photoelectric cell unit 254 includes a plurality of square solar cells 256 arranged in a row. The solar cells may for example be amorphous silicon thin-film solar cells or polycrystalline silicon thin-film solar cells. The input/output interface circuit 255 is configured to provide signals to the display area 251, and output electrical power generated by the photoelectric cell unit 254 to the battery 24. The battery 24 can store the electrical power generated by the photoelectric cell unit 254.

When the mobile phone 2 is located in a lighted environment, the photoelectric cell unit 254 generates electrical power. The electrical power is output to the battery 24 via the input/output interface circuit 255. The battery 24 is thereby charged, and stores the electrical power. Thus the stand-by time of the mobile phone 2 can be increased.

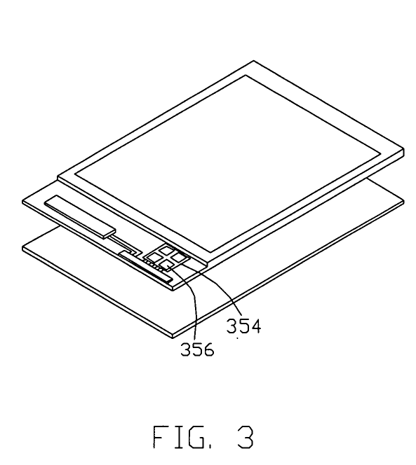

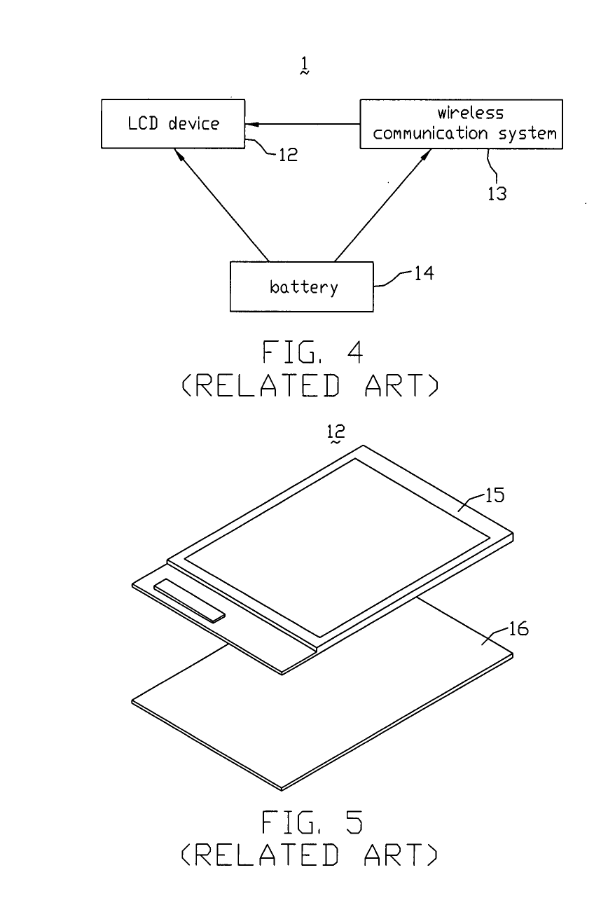

FIG. 3 an exploded, isometric view of an LCD device 32 of an alternative exemplary embodiment of the present invention. The LCD device 32 is similar to the above-described LCD device 22. However, a photoelectric cell unit 354 of the LCD device 32 includes a plurality of square solar cells 356 arranged in a regular m×n type matrix. Thus, depending on the configuration of, say, an associated mobile phone, each of the solar cells 356 can receive a same amount of light in a lighted environment.

In a further alternative embodiment, a photoelectric cell unit can be integrated on an LCD panel. Thus a volume of, say, an associated mobile phone can be reduced; and a process of assembly of the mobile phone can be simplified.

The present LCD panel and LCD device can be applied in any of various products that require an LCD panel and/or an LCD device, such as personal digital assistants (PDAs), video cameras, notebooks, and the like.

Those skilled in the art will readily appreciate that numerous modifications and alterations of the above-described embodiments may be made without departing from the scope of the principles of the present invention. Accordingly, the above disclosure should be construed as limited only by the metes and bounds of the appended claims or equivalents thereof.

What is claimed is:

1. A liquid crystal display (LCD) panel comprising:
a display area; and
a non-display area having a photoelectric cell unit provided thereat, the photoelectric cell unit configured to generate electrical power when irradiated by light.

2. The LCD panel as claimed in claim 1, wherein the non-display area further has a driver integrated circuit (IC) provided thereat, the driver IC configured for driving the display area.

3. The LCD panel as claimed in claim 1, wherein the non-display area further has an input/output interface circuit, which is configured to provide signals to the display area of the LCD panel and to output the electrical power generated by the photoelectric cell unit to a battery.

4. The LCD panel as claimed in claim 1, wherein the photoelectric cell unit comprises a plurality of solar cells arranged in a row.

5. The LCD panel as claimed in claim 1, wherein the photoelectric cell unit comprises a plurality of solar cells arranged in a matrix.

6. The LCD panel as claimed in claim 4, wherein the solar cells are amorphous silicon thin-film solar cells.

7. The LCD panel as claimed in claim 4, wherein solar cells are polycrystalline silicon thin-film solar cells.

8. A liquid crystal display (LCD) device comprising:
an LCD panel, the LCD panel comprising a display area and a non-display area, the non-display area having a photoelectric cell unit provided thereat, the photoelectric cell unit configured to generate electrical power when irradiated by light; and
a backlight module configured for illuminating the LCD panel.

9. The LCD device as claimed in claim 8, wherein the non-display area further has a driver integrated circuit (IC) provided thereat, the driver IC configured for driving the display area.

10. The LCD device as claimed in claim 8, wherein the non-display area further has an input/output interface circuit, which is configured to provide signals to the display area of the LCD panel and to output the electrical power generated by the photoelectric cell unit to a battery.

11. The LCD device as claimed in claim 8, wherein the photoelectric cell unit comprises a plurality of solar cells arranged in a row.

12. The LCD device as claimed in claim 8, wherein the photoelectric cell unit comprises a plurality of solar cells arranged in a matrix.

13. The LCD device as claimed in claim 11, wherein the solar cells are amorphous silicon thin-film solar cells.

14. The LCD device as claimed in claim 11, wherein solar cells are polycrystalline silicon thin-film solar cells.

15. A mobile phone comprising:
a wireless communication system configured for receiving and sending radio waves from and to other mobile phones;
a liquid crystal display (LCD) device, comprising:
an LCD panel, the LCD panel comprising a display area and a non-display area, the non-display area having a photoelectric cell unit provided thereat, the photoelectric cell unit configured to generate electrical power when irradiated by light; and
a backlight module configured for illuminating the LCD panel; and
a battery configured for respectively providing operation voltages to the wireless communication system and the LCD device.

16. The mobile phone as claimed in claim 15, wherein the non-display area further has a driver integrated circuit (IC) provided thereat, the driver IC configured for driving the display area.

17. The mobile phone as claimed in claim 15, wherein the non-display area further has an input/output interface circuit, which is configured to provide signals to the display area of the LCD panel and to output the electrical power generated by the photoelectric cell unit to the battery.

18. The mobile phone as claimed in claim 15, wherein the photoelectric cell unit comprises a plurality of solar cells arranged in a row.

19. The mobile phone as claimed in claim 15, wherein the photoelectric cell unit comprises a plurality of solar cells arranged in a matrix.

20. The mobile phone as claimed in claim 19, wherein the solar cells are selected from the group consisting of at least one amorphous silicon thin-film solar cell and at least one polycrystalline silicon thin-film solar cell.
